(19) United States
(12) Patent Application Publication
(10) Pub. No.: US 2023/0417485 A1
(43) Pub. Date: Dec. 28, 2023

(54) MODULAR SOLAR DRYER

(71) Applicants: Suryawanshi Sanjeev DAMODAR, Maharashtra Dhule (IN); Narendra NILKANTH PAWAR, Maharashtra Pune (IN)

(72) Inventors: Suryawanshi Sanjeev DAMODAR, Maharashtra Dhule (IN); Narendra NILKANTH PAWAR, Maharashtra Pune (IN)

(21) Appl. No.: 18/251,584

(22) PCT Filed: Nov. 3, 2021
(86) PCT No.: PCT/IN2021/051048

§ 371 Date: May 3, 2023

(30) Foreign Application Priority Data
Nov. 3, 2020 (IN) 202023047973

(51) Int. Cl. F26B 3/28; F26B 21/08; F26B 21/10; F26B 21/02; F26B 25/16

(52) U.S. Cl. CPC F26B 3/28; F26B 21/08; F26B 25/16; F26B 21/02; F26B 21/10

(57) ABSTRACT

A modular solar dryer (100) for drying and physical disinfection of ingredients is described that has a first hemispherical dome (104) that is positioned on base. A hemispherical second dome (208) is positioned below the first dome and includes hollow cylindrical cavity including utensils positioned on stand. A rectangular chamber is defined in a top end portion of the dryer (100) that includes a printed circuit board assembly (PCBA) (202), a motor (204) and an air circulator (206). The PCBA includes a controller (112), sensors and motor (204). The controller is configured to operate the dryer (100) in at least two modes. Notifications from the dryer are received on a user device (114). The dryer (100) operates on two modes of operation. A first mode is with moisture content based drying and a second mode is with exposed duration drying.

The present patent application has a reference to Indian Patent Application No. 1753/MUM/2015 filed on 1 May 2015. The present invention is improvement or modification of the invention claimed in specification the Patent Application No. 1753/MUM/2015.

### FIELD OF THE INVENTION

The present invention relates to solar dryers and more particularly to modular solar dryers for drying food products.

### BACKGROUND OF THE INVENTION

Food products are perishable by nature. Food preservation reduces wastage of a harvest surplus, allows storage for food shortages, and in some cases encourages export to high-value markets. Various procedures of food preservation are widely utilized for preservation of food products in the prior art. Drying is probably the most established and oldest method of food preservation. It involves removal of moisture from the food products to provide a product that can be safely stored for longer period.

Outdoor drying methods are being utilized due to their low cost and applicability on larger scales. This has many disadvantages since the things to be dried are placed in the open sky and there is serious risk of decay because of unfavorable climatic conditions like rain, wind, humidity and dust, and chances of contamination(birds droppings) also loss of produce to birds, insects and pests. The temperature achieved by outdoor drying is not sufficient for effective paste control. There is a loss of nutritive value of food due to exposure to ultraviolet rays of the sun. Outdoor food drying is completely dependent upon weather conditions causing the rate of drying with danger of mold growth. The process also requires large area of land, takes time and it is highly labor intensive, as it is attentive process. With agricultural and industrial development, artificial mechanical drying came into practice, but artificial mechanical drying systems are highly energy demanding and expensive that ultimately increases product cost.

Recently, efforts for improving “open air drying” have prompted “solar drying”. The solar drying system utilizes solar energy to heat up air and to dry any food substance filled that is beneficial in reducing wastage of agricultural product and helps in preservation of agricultural product. Based on the limitations of the natural sun drying e.g. exposure to direct sunlight, liability to pests and rodents lack of proper monitoring, and the escalated cost of the mechanical dryer, a solar dryer is therefore a better alternative to cater for this limitation. Devices for drying such as a solar dryer or solar cooker have already been known in prior art, but these devices are limited in scope. Unfortunately, these devices are awfully expensive, slow, and complex to use and require large space.

There is a need of a modular solar dryer that can be used for drying, heating and for pest control by physical disinfection. There is also a need for a solar dryer that monitors temperature and related humidity for effective drying. There is also a need for a solar dryer that preserves food stuff without degrading the nutritive content, aroma, flavor, and aesthetics.

### BRIEF DESCRIPTION OF DRAWINGS

The objectives and advantages of the present invention will become apparent from the following description read in accordance with the accompanying drawings wherein

FIG. 1 is a perspective view of a modular solar dryer in accordance with a preferred embodiment of the present invention;

FIG. 2 is an exploded view of the modular solar dryer of FIG. 1 along axis-Y;

FIG. 2A is a sectional front view of the modular solar dryer of FIG. 1;

FIG. 2B is an enlarged view of top end portion of the modular solar dryer of FIG. 1 that shows positioning of a circulator, a PCB and a cover relative to a handle;

FIG. 2C is an enlarged view of a solenoid valve of the modular solar dryer of FIG. 1;

FIG. 2D is a top perspective view of a PCBA of the modular solar dryer of FIG. 1;

FIG. 3A is a systematic representation of the modular solar dryer in accordance with the present invention of FIG. 1;

FIG. 3B is an operational flow of the modular solar dryer operating in moisture content based drying mode in accordance with the present invention of FIG. 1;

FIG. 4 is an operational flow chart of the modular solar dryer operating in exposed duration based drying mode in accordance with the present invention of FIG. 1;

FIG. 5 is a perspective view of a first embodiment of the modular solar dryer of the present invention;

FIG. 5A is a sectional front view of the first embodiment of the modular solar dryer of FIG. 5;

FIG. 6 is a perspective view of a second embodiment of the modular solar dryer of the present invention;

FIG. 6A is a top perspective view of a first dome of modular solar dryer of FIG. 6;

FIG. 6B is a top perspective view of the first dome and a second dome with tray with central support of modular solar dryer of FIG. 6;

FIG. 7A is a top perspective view of the second dome of modular solar dryer of FIG. 6;

FIG. 7B is a perspective view of the second dome in assembled position of modular solar dryer of FIG. 6;

FIG. 8 is a perspective view of the tray with central support of modular solar dryer of FIG. 6;

FIG. 9 is a perspective view of the dryer showing air change unit of the modular solar dryer of FIG. 6;

FIG. 10 shows a first drying mode position and a second disinfection mode position of a knob of the modular solar dryer of FIG. 5,

FIG. 11 shows a cross sectional view of the knob of the modular solar dryer of FIG. 5;

FIG. 12 is a graph showing solar radiation variation observed in the atmosphere to which the modular solar dryer of FIG. 1 is exposed during the experimentation; and

FIG. 13 shows a graph of daily temperature variation observed while using the modular solar dryer of FIG. 1 while exposed to solar radiations.

### SUMMARY OF THE INVENTION

In one aspect, the present invention is a modular solar dryer for drying and physical disinfection of ingredients. The modular solar dryer includes a first hemispherical dome, a hemispherical second dome, a base, a seal, a set of utensils, a cylindrical chamber and a user device. The first dome id positioned on a circular base. The second dome is positioned below the first dome defining a drying a chamber between the inner surface of the second dome, an inner surface of the base and a platform on which dryer of the present invention is positioned. The base receives the first dome, the second dome and the seal along the periphery. The set of utensils are positioned on a stand within the drying chamber.

The cylindrical chamber is defined in a top end portion of the dryer and includes a printed circuit board assembly (PCBA), a motor and an air circulator. The cylindrical chamber is covered from top by the cover. The PCBA includes a controller, a first sensor, and a second sensor that controls the motor and a solenoid valve. The controller is configured to operate the dryer in two modes. A first mode of the dryer is associated with moisture content with temperature based drying and a second mode of the dryer is associated with temperature and exposed duration based drying.

The user device includes a controller and a display. The controller is configured to receive real time notifications related to drying updates and to communicate with the controller of the dryer.

Some portion of the first dome and second dome is always normal to the incident solar energy during drying operation. The first dome and second dome are made using a multiple straight planner segments that are bent in vertical direction using a single radius or a multiple radii and such segment are joined together at the ends to define arcuate shape. Further, the air space between the first dome, the second dome and the base defines an insulation preventing the heat loss from the dryer.

A pair of utensils is coated with heat absorbing material to absorb heat energy. The solenoid valve is positioned on the base for opening and closing of the air passage as per the controller signals. The air circulator is activable by the controller as per time interval, temperature, and humidity. The first sensor is humidity sensor and the second sensor is temperature sensor. The controller monitors time, temperature and humidity inside the dryer, and maps such parameters to the user device.

The user device is configured to receive real-time updates regarding drying process notifications related to temperature, humidity and drying duration from the controller. Further, the user device is configured to observe and control the operation of the dryer by sending the instructions to the controller as per the desired drying needs.

In one embodiment of the present invention a modular solar dryer for drying and physical disinfection of ingredients includes a first dome, a base, a second dome, a drying chamber, a utensil assembly and a seal. The first dome is hollow and hemispherical in shape and includes a handle attached at top centre of its outer side. The base is circular ring that receives the first dome along periphery of the first dome. The second dome is hollow and hemispherical shaped.

The drying chamber is defined by a space between the second dome, an inner diameter of the base, and a platform. The utensil assembly includes a first utensil, a second utensil, for holding items to be dried and a stand that is positioned within the drying chamber. The seal is positioned in the proximity with the peripheral edge of the base on bottom side.

The modular solar dryer in accordance with first embodiment is operable in two modes such as a first drying mode and a second disinfection mode that are operated by a knob in association of the vent valve.

In yet another embodiment of the present invention, a modular solar dryer for drying and physical disinfection of ingredients includes a first dome, first support grill, a second dome, a second support grill a hemispherical chamber a tray stand, a perforated pipe, a sliding door, an air change unit and a lifting unit.

The first dome is formed by plurality of curved segments, when assembled together on the first support grill. The support grill is assembled by arranging a plurality of curved members to a movable flanged pipe and a bottom ring. The second dome assembled by arranging plurality of curved segments on a second support grill. The support grill is assembled by arranging a plurality of curved members to the flanged pipe and a bottom ring. The hemispherical chamber is formed by a space between the second dome and base surface.

The tray stand is rotatable about the axis Y-Y on a guide railing with help of a rolling wheel. The sliding door is slidably positionable between a guiding track and the guide rail. The perforated pipe is a structural member that includes tray partitions and the perforated pipe connects with flange pipe. The flanged pipe connects the first dome and the second dome to the perforated pipe and enables air flow passage from hemispherical chamber to outer environment.

The air change unit includes of a pair of plates, with a plurality of slits that enables controllable air flow through the dryer. The lifting unit is positioned on the support grill of first dome for facilitating the air change mechanism.

The modular solar dryer of the present invention is used for drying, heating and for pest control by physical disinfection. It monitors temperature and related humidity for effective drying and preserves food stuff without degrading the nutritive content, aroma, flavor, and aesthetics. The dryer disclosed in accordance with the present invention is advantageously efficient as there is maximum utilization of the available solar energy.

### DETAILED DESCRIPTION OF THE INVENTION

The invention described herein is explained using specific exemplary details for better understanding. However, the invention disclosed can be worked on by a person skilled in the art without the use of these specific details.

References in the specification to “one embodiment” or “an embodiment” means that particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

In general aspect, the present invention is a modular solar dryer that is used for drying using solar energy. The modular solar dryer is designed in such a way that drying is done using solar energy and without loss of nutrients, aroma, flavor, and aesthetics.

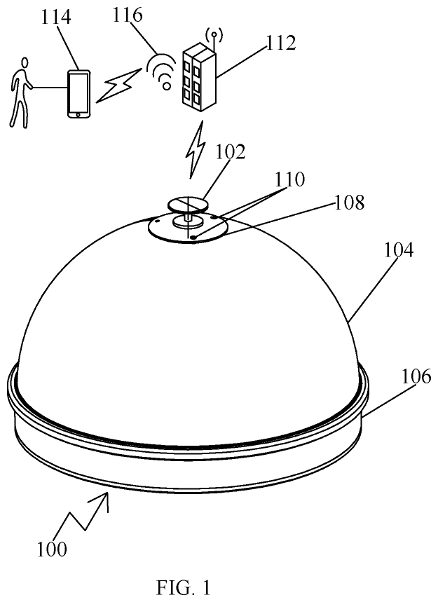

Referring to FIG. 1, a modular solar dryer 100, hereinafter referred as dryer 100, in accordance with a preferred embodiment of the present invention is described. The modular solar dryer 100 includes a handle 102, a first dome 104, a base 106, a cover 108 and a controller 112. The first dome 104 is positionable on the base 106. The first dome 104 includes a cover 108 that is positioned on the top of the first dome 104. The handle 102 is centrally positioned on the cover 108 that is intern positioned on the top of the first dome 104. The cover 108 includes a plurality of holes 110 for securely connecting the cover 108 on the first dome 104. The controller 112 of the modular solar dryer 100 is preferably remotely located. The controller 112 communicates with the solar dryer 100 and a handheld device 114 through any communication medium 116 such as internet, infrared signals or electromagnetic signals that are known in the prior art.

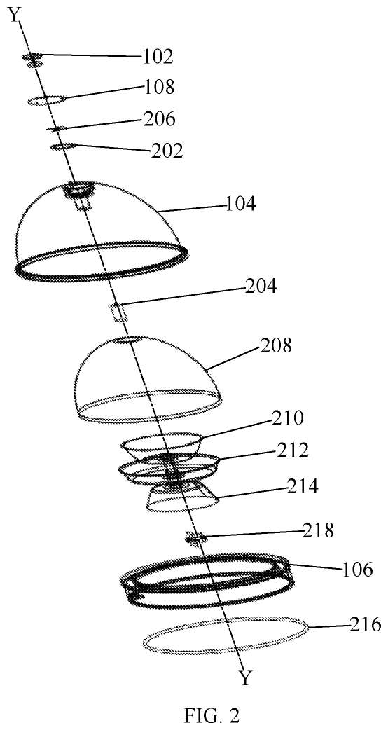

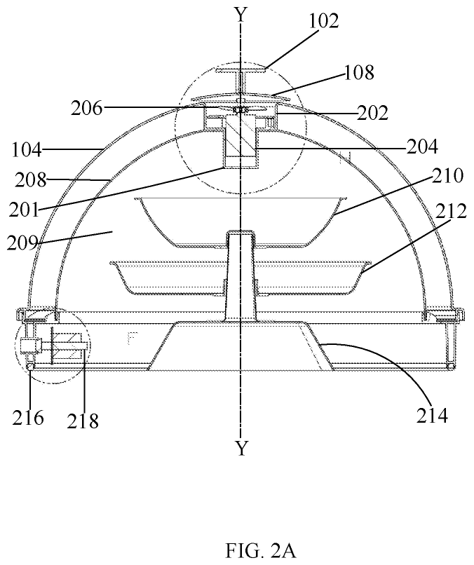

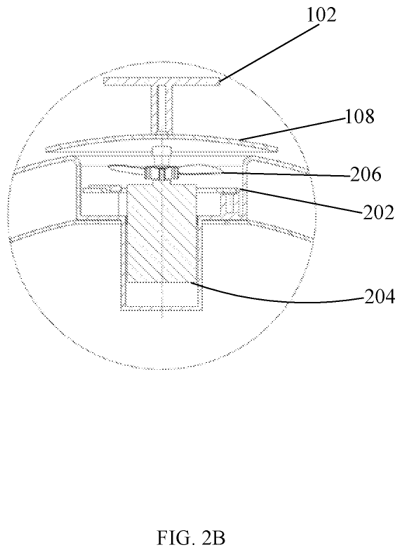

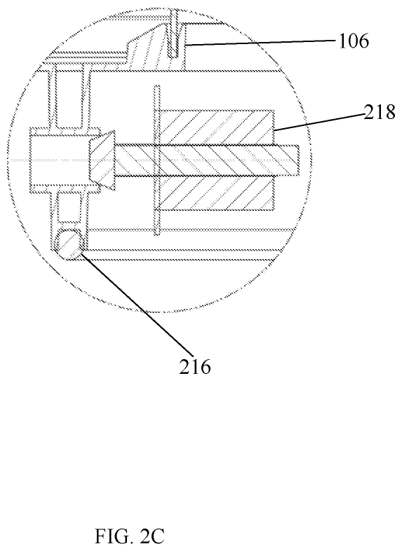

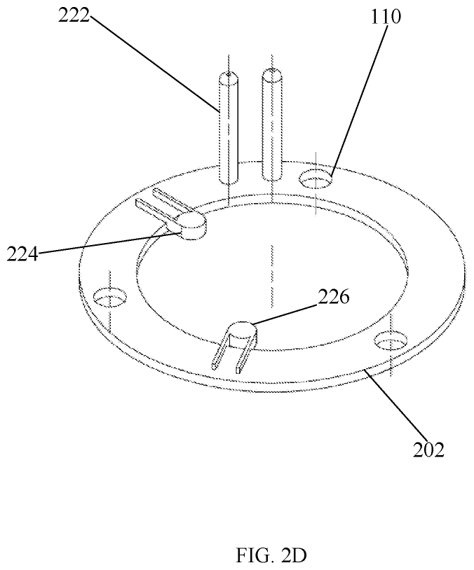

FIG. 2 shows an exploded front perspective view of the modular solar dryer 100 along an axis-Y in accordance with preferred embodiment of present invention. Accordingly, the handle 102 along with the cover 108, a PCBA 202, a motor 204, and an air circulator 206, the first dome 104, the second dome 208 and the utensils 210, 212 are positioned preferably along axis-Y that is colinear with a central axis of the device 100. The stand 214 is positionable on any flat surface to receive solar radiation from all sides. The stand 214 is advantageously positioned such that the stand 214 is surrounded by base 106. The first dome 104 and second dome 208 are uniformly and coaxially positioned on the base 106. The first dome 104 and second dome 208 are removably positionable on the base 106 along the axis-Y.

The first dome 104 and the second dome 208 are coaxial, however, having different diameter such that the diameter of the first dome 104 is larger than the diameter of the second dome 208. The first dome 104 and the second dome 208 are separated by a uniform distance from each other and together define an integrated dome. The first dome 104 and the second dome 208 are erected on a base 106. The integrated dome defined by the first dome 104, and the second dome 208 has a heating chamber i.e. a drying chamber 209 that is defined by the space below the second dome 208 and within an inner surface of the base 106. It is to be noted that the drying chamber 209 is the defined by the space confined by inner side of the second dome 208 and inner surface of the base 106 and a platform on which the drier 100 is positioned. In this preferred embodiment of the present invention, the inner diameter of base 106 is approximately 324 mm, and outer diameter is approximately 364 mm that enables the dryer 100 to maintain an optimal gap between the first dome 104 and the second dome 208. The second dome 208 and first dome 104 is consecutively removable from the base 106 by lifting the respective dome 104 and 208 in the upward direction.

Now referring to FIGS. 2A-2D a top end portion of the dryer 100 includes a cylindrical chamber 201 that includes a printed circuit board assembly (PCBA) 202, a motor 204 and an air circulator 206. The chamber 201 is closed from the top by the cover 108. The air circulator 206 is coupled to a shaft of the motor 204. The second dome 208 includes a first utensil 210, a second utensil 212, and a stand 214. A central axis of the handle 102, the motor 204, the first utensil 210 and the second utensil 212 is co-liner with an axis-Y that is normal to a plane of base 106 in accordance with the present invention. The first utensil 210 is positioned on the second utensil 212 and the second utensil 212 is intern positioned on the stand 214 that is positionable inside the base 106.

The dryer 100 further includes a seal 216, a solenoid valve 218, a wiring channel (Not Shown), light emitting diodes (LED) 222, a first sensor 224 and a second sensor 226. The seal 216 is positioned along the peripheral bottom surface of the 106 base. The solenoid valve 218 is positioned at predefined groove in the base 106. The LEDs 222, the sensors 224 and 226 are positioned on the PCBA 202.

The PCBA 202 is guarded with the cover 108 that includes a plurality of through holes 110 positioned at predefined distance along its periphery. In this preferred embodiment, the PCBA 202 includes a pair of light emitting diodes (LED) 222, the first sensor 224 and a second sensor 226. The LEDs 222 or the light emitted by the LEDs 222 is visible through the outer side of the cover 108. The solenoid valve 218 is positioned at the base 106. The wiring channel connects the solenoid valve 218 and the air circulator 206 with the PCBA 202.

In accordance with the preferred embodiment of the present invention, the material of first dome 104 is transparent material preferably plastic. The second dome 208 advantageously that defines an absorber in accordance with the present invention is made up from heat absorbing material. In another embodiment, the second dome 208 is coated with heat absorbing material such that outer surface is coated with heat absorbent media and inner surface has good emissivity which radiates the absorbed heat energy to the ingredients kept inside the absorber for drying purpose.

The utensils 210, 212 are also coated with heat absorbent media to absorb solar radiation. In accordance with the present invention, the first dome 104, and the second dome 208 are integrated as a one single unit that has handle 102 on the top. It is to be noted that first dome 104, second dome 208 are preferably coaxial along axis-Y. However, in other embodiments of the present invention the first dome 104 and second dome 208 may not be coaxial.

In accordance with the preferred embodiment of the present invention, the first dome 104 and second dome 208 are of hemispherical shape so that some part of the glazing and the absorber surface is always normal to the incident solar energy and the base 106 is preferably cylindrical in shape. The shape of first dome 104 and second dome 208 is preferably hemispherical in the preferred embodiment of the present invention. It is to be noted that the hemispherical shape is replaceable by arcuately shaped domes in other embodiments of the present invention. The first dome 104 and second dome 208 are made using a multiple straight planner segments that are bent in vertical direction using a single radius or a multiple radii and such segment are joined together at the ends to define arcuate shape.

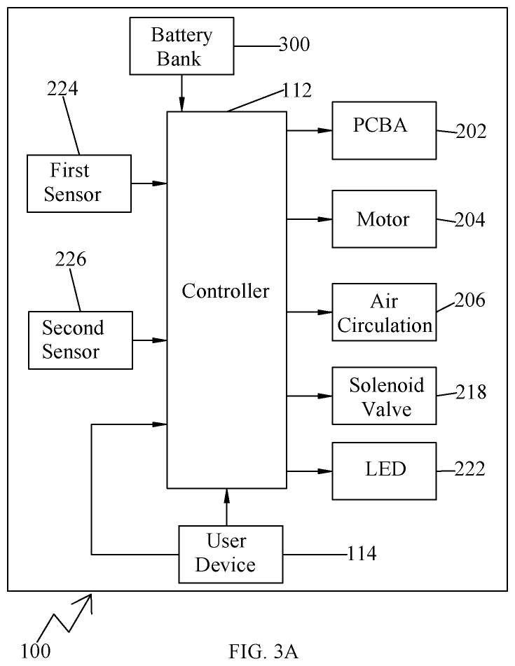

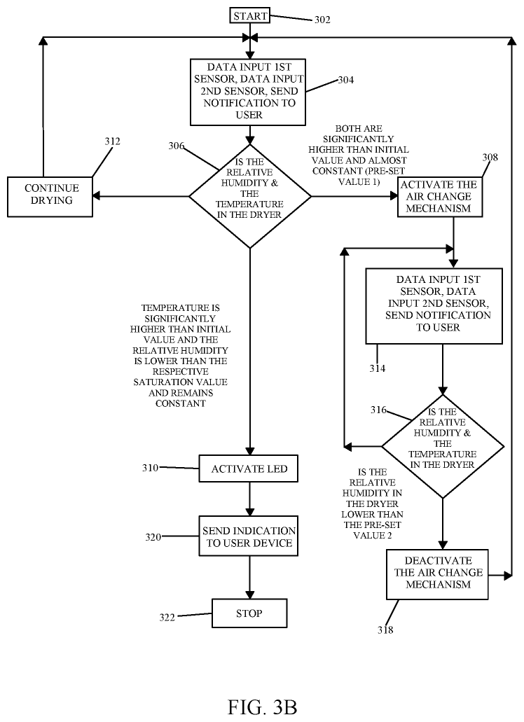

Referring to FIG. 3A, the dryer 100 in accordance with the present invention 100 is described. The dryer 100 includes controller 112, the PCBA 202, motor 204, air circulator 206, solenoid valve 218, the first sensor 224, the second sensor 226, battery bank 300. The dryer 100 relates to the user device 114.

The controller 112 is configured to receive input from the first sensor 224, and the second sensor 226. The user device 114 communicates with the controller 112. The controller 112 is configured to control the air change mechanism in the dryer 100 by operating the air circulator 206 and the solenoid valve 218. The controller 112 of the dryer 100 is configured to communicate with the user device 114 and has two modes of operation i.e. a first mode and a second mode. The first mode includes moisture content based drying, and the second mode includes exposed duration based drying. The user device is configured to select one of these modes for operating the dryer 100. The communication medium 116 is any wired or wireless data communication system. It is noted however that the communication medium and operating platform of the dryer 100 may differ in other embodiments of the present invention.

In this embodiment, the user handheld device 114 is customized device that includes a controller, memory chip, data base, transmitter, transducers, a touch screen display, input device and a plurality of ports. The user device is configured to communicate with the dryer in accordance with the present invention. The touch screen display enables user to receive real time notifications related to temperature and relative humidity in the dryer 100. In other embodiments of the present invention the user device may be smartphone, tablet, laptop, desktop computer system etc. that is configured to receive notifications of the present system.

Now referring to FIG. 3B, an operational flow of the dryer 100 operating in the first mode is described. In step 302, the system 100 is initialized. In step 304, the input from first sensor and second sensor is received by the controller and sent to the user device 114.

In a next step 306, the data received from first sensor 224 and second sensor 226 is analyzed. If the temperature and the relative humidity in the dryer 100 are higher than the predefined values and remains constant for a predefined duration then the control is passed to step 308. If the temperature is significantly higher than the initial value and the relative humidity is lower than the saturation value and both i.e. temperature and the relative humidity remains constant over set period, then the control is passed to step 310 or else the control is passed to step 312 wherein the drying process is continued and the control is passed to step 304 and 306.

In step 308, the air change mechanism is activated. In this step, the solenoid valve 218 is activated by the controller 112 opening the air passage, and the air circulator 206 is activated by the controller 112 that replaces the air in the dryer 100 with the fresh atmospheric air that is inducted in dryer 100.

In next step 314, where the data from the first sensor 224 and second sensor 226 is stored in the controller 112 and the controller sends the data to the user device 114.

In step 316, the data from the first sensor 224 and second sensor 226 is analyzed. If the relative humidity in the dryer 100 is lower than the pre-set value 2, then the control is passed to step 318 wherein the airflow mechanism is deactivated or else the control is passed back to step 314. After step 318, the control is passed again to step 304.

In step 310, the drying process is complete and the controller 112 activates respective LED.

In next step 320, indication and notification is sent to the user device.

In step 322, the drying process control is terminated.

Now referring to FIG. 3C, an operational flow of the dryer 100 operating in the second mode is described. In step 352, the operation of the dryer 100 is initialized.

In next step 354, the control unit 112 receives the input from the first sensor 224 and second sensor 226. The control is transferred towards step 356.

In step 356, the controller 112 generates the notifications based on inputs received in previous step, and sends those notifications to user device at predefined time interval. The respective notifications are displayed on the user device 114.

In step 358, if the data received from first sensor 224 or second sensor 226 in the dryer 100 is higher than the pre-set value 2 then control is transferred to step 360, otherwise control is transferred towards step 370.

In steps 360, the control unit activates air change mechanism by activating solenoid valve and air circulator.

In next step 364, the control unit receives the input from the first sensor 224 and second sensor 226.

In step 366, if temperature in the dryer is lower than the pre-set value 3 then control is transferred to step 368 otherwise the control is transferred towards step 364.

In step 368, the controller 112 deactivates air change mechanism and the control is transferred to step 354.

In step 370, if the data received from first sensor or second sensor in the dryer is higher than the pre-set value 1 then the control is passed to step 372 else the control is passed to step 362 and then to step 354.

In step 372, if the drying duration greater than predefined duration 2 then the control is passed to step 374 else the control is passed to step 362 and then to step 354.

In steps 374, control unit activates LED for predefined time interval.

In step 376, the control unit prepares the notifications based on inputs received in previous step and sends those notifications to user device at predefined time interval and activates the air change mechanism. The controller 112 waits for an input that is generated by human intervention to stop the air change mechanism. After human intervention, the control is transferred towards step 378. In step 378, the operation of the system is terminated.

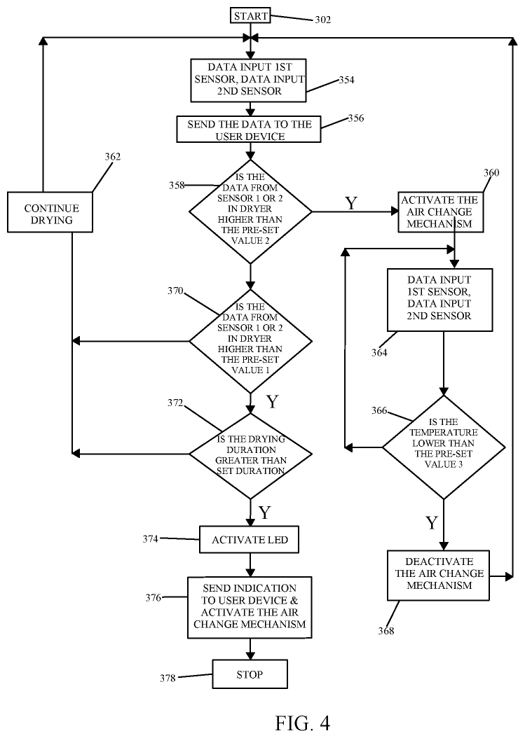

Now referring to FIGS. 1 to 4, in operation, the utensils 210, 212 are placed on the stand 214 that is placed on any planar platform preferably, where solar radiations are received. The utensils 210, 212 are filled with items to be dried, for example, food items like cereals. If several items to be dried separately, then they are placed in different utensils. The utensils 210, 212 are positioned in close proximity with the second dome 208 such that, the hemispherical shape of the first dome 104 and second dome 208 are coaxial with axis −Y.

During sunshine hours, the incident solar energy enters into the dryer 100 from the transparent first dome 104 and gets absorbed by the second dome 208 resulting in increased temperature inside the dryer 100.

The seal 216 present at base 106, seals the first dome 104. The base 106 also seals the first dome 104 and second dome 208. The seal 216 is used to prevent the leakage of the air at the interface with the resting platform on which the solar dryer 100 is placed. The air space between the first dome 104 and the second dome 208 advantageously defines insulation that helps in preventing the heat loss.

In the present invention, the first sensor 224 is humidity sensor and the second sensor 226 is temperature sensor. Initial humidity in the atmosphere is noted in the controller 112. For the ingredient treatment where it is temperature sensitive, the controller 112 activates, the air change through the air circulator 206, the moment the temperature increase beyond pre-set value T1. The air circulator 206 stops and the solenoid valve 218 closes, the moment temperature drops below the pre-set value. Thus, maintaining the temperature in the dryer 100 to the optimal level pre-set range. Once the temperature has been maintained for the pre-set time, the controller 112 activates the air circulator 206 and the solenoid valve 218, completely refreshes the air inside the dryer 100 and activates the LED 222 for predefined time interval to indicate that the treatment of the ingredient is complete.

The controller 112 also shows the data on a display of the user device 114, such as real time temperature and the humidity of air inside dryer 100. The representation of the data can be in the numerical form or it can be also in graphical form to show the temperature and the humidity pattern over the given period.

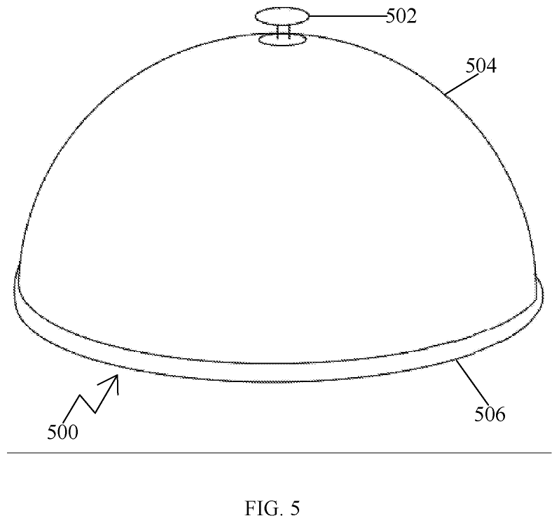

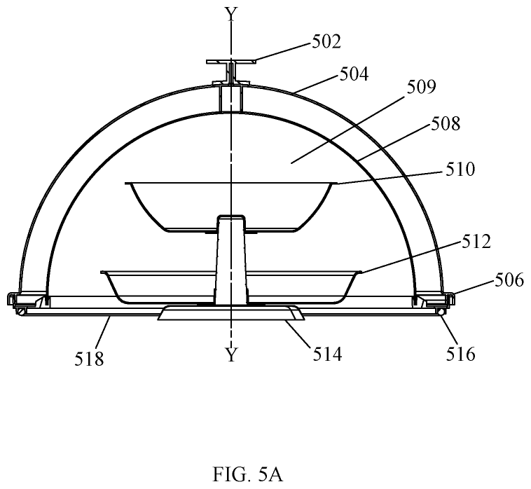

Now referring to FIGS. 5 and 5A, a first embodiment 500 of the modular solar dryer 100 is described. The modular solar dryer 500 includes a handle 502, a first dome 504, a base 506, a second dome 508, a utensil assembly 503, a seal 516, and a resting floor or a platform 518. The utensil assembly 503 includes a first utensil 510, a second utensil 512, and a stand 514. In this one embodiment, the utensil assembly 503 includes a plurality of utensils 510, 512. The number of utensils and the shape may differ in other embodiments of the present invention. The first dome 504, the second dome 508 are erected on a base 506. The first dome 504 and the second dome 508 form a composite that is positioned on the base 506. The space between the second dome 508, an inner diameter of the base 506, and a platform 518 defines a drying chamber 509.

The resting floor 518 acts as base floor of the dryer 500. The handle 502 is attached at top centre of the first dome 504. The first dome 504 and second dome 508 are uniformly positioned on the base 506. The first dome 504 and second dome 508 is positionable over utensil assembly 503. In accordance with the preset invention, the second dome 508 defines as an absorber that is made of a material having good thermal conductivity. The second dome 508 includes an absorber layer on top. In another embodiment, the outer surface of the second dome 508 is coated with heat absorbing material preferably having selective coat on the top of heat absorbing material. Inner surface has good emissivity that radiates the absorbed heat energy to the ingredients which enhances drying of the ingredients kept inside the drying chamber 509 for drying purpose. The first utensil 510 and second utensil 512 are positioned on the stand 514 for holding items to be dried. The seal 516 is positioned on the peripheral edge of the base 506 on bottom side.

The first dome 504 and second dome 508 is preferably designed in hemispherical or curved shape and the base 506 is preferably circular in shape.

Now referring to FIGS. 5 to 5A, in operation, the handle 502, the first dome 504, the second dome 508 and the utensil assembly 503 are positioned preferably coaxially and define a common axis-Y. The utensil assembly 503 is positioned on any flat surface that can receive solar radiation. The utensil assembly 503 is surrounded by base 506. The first dome 504 and second dome 508 are uniformly positioned over the base 506. The first dome 504 and second dome 508 are insertable on the base 506 such that it matches the vertical axis of the utensil assembly 503 and by moving it in a downward direction. The second dome 508 and first dome 504 are consecutively removable from the base 506 by moving it in the upward direction. The utensil assembly 503 is positioned in proximity with the second dome 508. The central axis of the dome and central axis of the utensils are coaxial along axis Y-Y.

In accordance with the first embodiment of the present invention, the material of first dome 504 is transparent material preferably plastic. The first dome 504 is transparent in nature. The second dome 508, as an absorber is made up from heat absorbing material or coated with heat absorbing material.

For example, in this embodiment of the present invention the outer diameter of base 506 is approximately 364 mm, and inner diameter is approximately 324 mm.

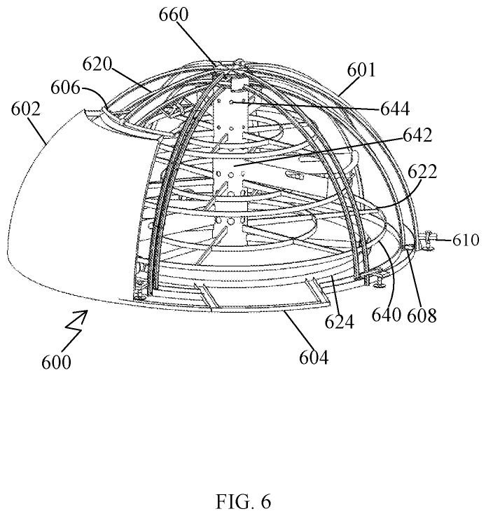

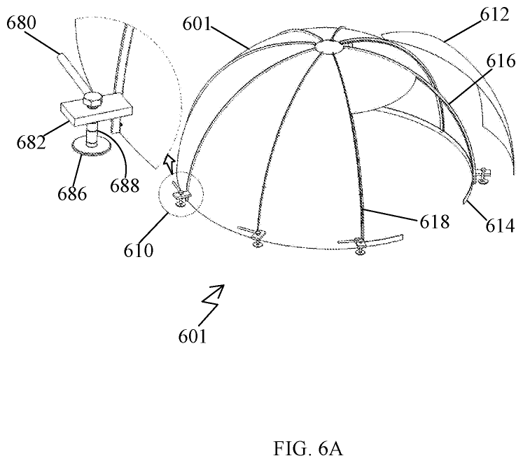

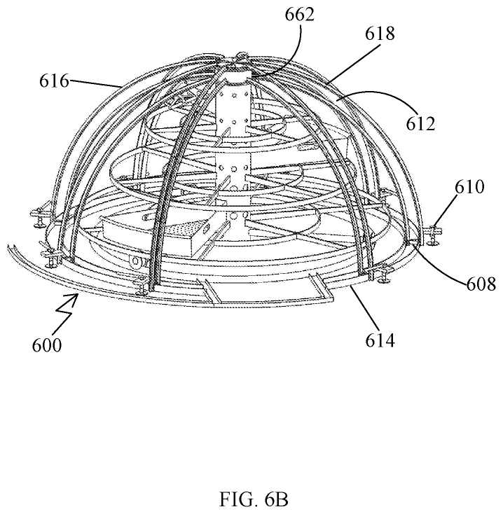

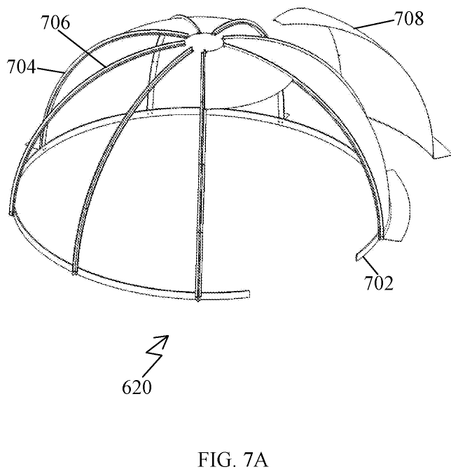

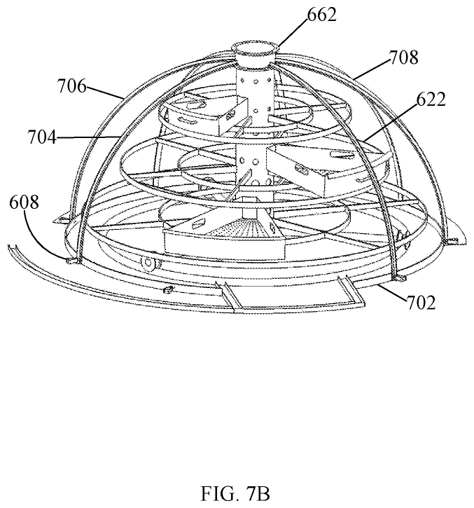

Now referring to FIGS. 6, 6A, 6B, 7A and 7B a second embodiment of the modular solar dryer is described. Accordingly, the modular solar dryer 600 includes a first dome 601, a sliding door 602, a guide track 604, a plurality of “U” clips 608, a lifting unit 610, a support grill 618, a second dome 620, a hemispherical chamber 622, a stand 640, a central perforated pipe 642, and an air change unit 660.

The first dome 601 includes plurality of curved segments 612 that are assembled together on the first support grill 618. The support grill 618 is assembled by assembling a plurality of curved members 616 to a movable flanged pipe 662 and a bottom ring 614. The flanged pipe 662 slides in Y-Y axis direction over a perforated pipe 642. The plurality of “U” clips 608 are positioned on bottom ring 702 of second dome 620.

The second dome 620 is assembled by arranging plurality of curved segments 708 on a second support grill 704. The arcuate frame 704 is assembled by assembling a plurality of curved members 706 to the flanged pipe 662 and the bottom ring 702. The hemispherical chamber 622 is formed by a space between the second dome 620 and base surface. The tray stand is rotatable about the axis Y-Y on a guide railing 624 with help of a rolling wheel 812. The sliding door 602 is slidably positionable over the guide track 604 and includes a door handle (not seen in fig). The guide track 604 is connected to the stand 640.

The air change unit 660 includes of a pair of plates 902 and 904, with a plurality of slits that enables controllable air flow in the dryer. The lifting unit 610 for air change is attached to the support grill 618 of first dome 601. The lifting unit 610 includes a predesigned graduated bolt 688 with a lever 680 secured in a threaded plate 682 along with a bearing washer 686. The sliding door 602 with lock can be opened and closed with the help of door handle 810 during loading and unloading. The sliding door 602 is supported by a plurality of castor wheels that roll over the guide track 604 and that are supported by a top guide 606.

Further, the dryer 600 includes a stand 640 that includes the central perforated pipe 642. An axial blower 906 in installed at the top of the central perforated pipe 642 in a movable flanged pipe 662. A plurality of perforations 644 is variable in diameter as well as in number along the axis Y-Y. The first dome 601 and second dome 620 are combined and lifted by the lifting unit 610.

Referring to FIGS. 7A and 7B, the second dome 620 as an absorber is supported on a grill 704 that is a frame made of a plurality of arcuate members. The absorber surface of second dome 620 is made by a plurality of arcuate panels 708. The grill 704 includes a plurality of arcuate members 706 coupled to the flanged pipe 662 on a top side and a bottom ring 702 on the bottom side. The second dome 620 is assembled by securing plurality of panels 708 on grill 704. A plurality of “U” clips 608 for securing bottom ring 614 of first dome 601 are positioned on the bottom ring 702 of second dome 620. The hemispherical chamber 622 is defined by the space between second dome 620 and base surface.

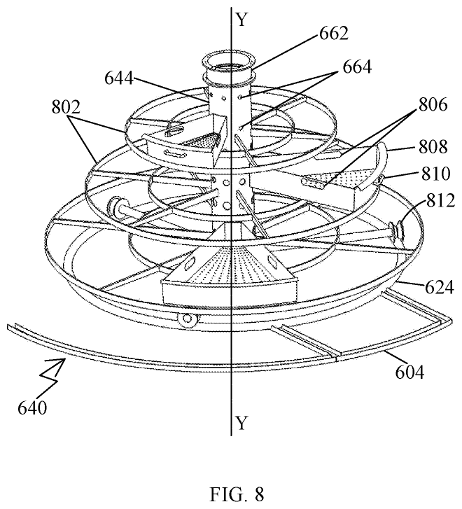

Referring to FIG. 8, the modular solar dryer 600, includes the tray stand 640 with a plurality of tray partition 802 with horizontal support, a plurality of trays 808. The trays 808 include a plurality of handles 806 for easy loading and unloading of material in the dryer 100. The tray stand 640 rotates about axis −Y on guide railing 624 with help of rolling wheel 812. The guide track 604 is for door operation.

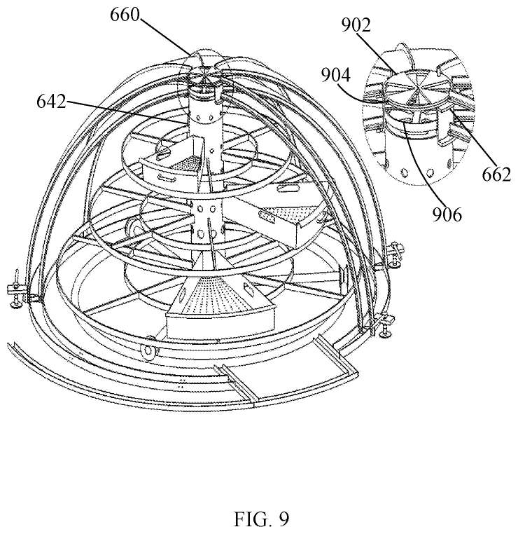

Referring to FIG. 9 the air change unit 660 is described. The air change unit 660 is attached to the flanged pipe 662. The air change unit 660 includes of a pair of plates 902 and 904, with a plurality of slits that enables controllable air flow through the dryer 600. Among the pair of plates, the plate 904 is fixed and the plate 902 is configured to control the flow. The plate 904 is attached to the flanged pipe 662. The flanged pipe 662 connects the first dome 601 and through second dome 620 to the perforated pipe 642 and enables air flow passage from hemispherical chamber 622 to environment. An axial blower 906 is installed in between the perforated pipe 642 and the movable flanged pipe 662. An air mixing blower 908 is attached inside to second dome 620.

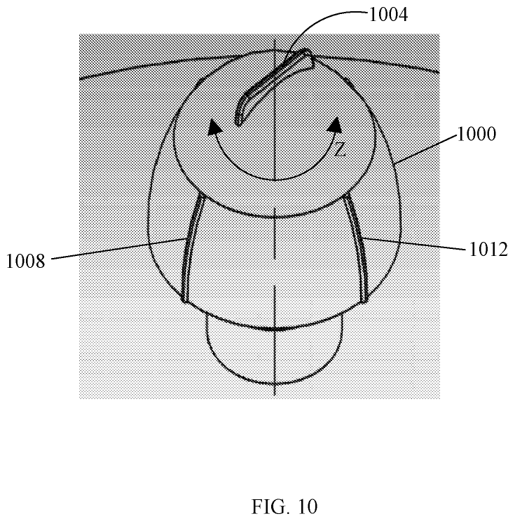

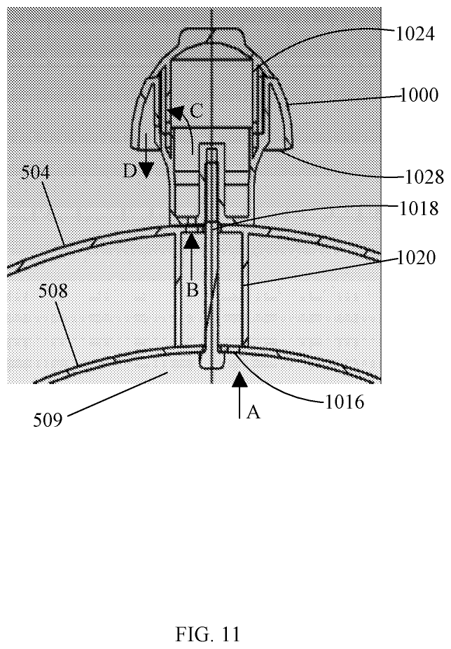

Referring to FIGS. 10 and 11, the solar dryer 500 is operable in two modes such as a first drying mode and the second disinfection mode. A knob 1000 has two positions i.e. a first drying mode position and a second disinfection mode position. The knob 1000 is movable from the first position to the second position and vice versa as shown in the directions indicated by arrow ‘Z’ by using a handle 1004. The knob 1000 has two ribs 1008 and 1012 in accordance with the first position and the second position.

The second dome 508 includes the vent 1016, the inner space between cylindrical hollow ribs which is an extension of the first dome 504 and the external surface of the second dome forms an air chamber 1020 positioned above the vent 1016, and a hole 1018 defined in the first dome 504. The air chamber 1020 is defined between the first dome 504 and the second dome 508. The body of knob 1000 includes air vent valve 1024 and exit slot 1028. In the first drying mode the handle 1004 of the air vent 1024 is aligned with the rib 1008 causing the air vent valve 1024 to open that allows air received from the air chamber 1020 to pass through the air vent valve 1024 and the exit slot 1028 to the atmosphere.

In the first drying mode, an air change is desired in accordance with the present invention. The ingredients inside the drying chamber release the moisture into the air in the drying chamber 509. The air inside the drying chamber absorbs the moisture. With increase in the moisture content, the air becomes saturated. Once the air is saturated, the drying process comes to halt. In accordance with the present invention, the saturated air has to be discharged into the atmosphere and that has to be replaced by the fresh atmospheric air. When the knob is on the first drying mode, the handle 1004 of the air vent 1024 is aligned with the rib 1008. As the air inside the heating chamber 509 gets heated up along with the ingredients to be dried, the moisture is released by the ingredients and the same moisture gets absorbed by this air inside the heating chamber 509. It is observed that there is a thermal imbalance caused in the air inside the heating chamber 509.

The hot saturated air rises and the relatively cold dry air remains at the lower level. Said hot saturated air rises further and finds the path towards exit valve 1024 through the vent hole 1016 defined inside the absorber i.e. second dome 508, the hole 1018 on the first dome 504 and the knob 1000. The air that reaches the cavity in the knob 1000 is released inside the atmosphere through the exit slot 1028 in the exit valve 1024 that aligns with exit slot in the knob 1000. Fresh and relatively cold, dry air gets into the drying chamber 509 at the bottom through a slit (Not Shown) on a sealing mounted on the base 106. The air change here after continues due thermo-siphon process in a natural way.

In the second dis-infection mode, the air inside the heating chamber, 509 though reaches the cavity in the knob 1000 due the thermo-siphon process, it cannot find its way to the atmosphere and hence there is no change of air in this mode of operation. The ingredients in the drying chamber 509 and the air in the drying chamber gets heated with the absorption of the solar radiations by the absorber i.e. the second dome 508. The ingredients release the moisture to the air inside the drying chamber 509. This air gets saturated and remains saturated with the absorbed moisture. The drying process stops here after. The ingredients are continued to be exposed to elevated temperature enabling the disinfection. It is however, noted, that in another embodiment, there is no slit provided in the sealing. This embodiment works only in one default mode of dis-infection with a limited drying due to the inherent natural self-adjusting infiltration and exfiltration in the solar dryer 500.

Now referring to FIGS. 6 to 9, in operation, the ingredients to be dried, for example, cereals, dry fruits etc. are loaded in the trays 808. In the process of loading the ingredients in the tray, the door 602 is opened by sliding on the railing 604. After that, the trays 808 are removed. The trays 808 are loaded with the ingredients and are placed on one or more tray partition, respectively. The tray partition is manually rotatable either in clockwise or anti clockwise directions. Once the trays 808 are loaded in the dryer 600, the door 602 is closed and system is ready for drying.

In accordance with the present invention, solar radiations penetrate through the first dome 601 and are absorbed by the second dome 620 that heats air inside the hemispherical chamber 622. Due to said heating, temperature inside, the hemispherical chamber 622 gradually rises. With increase in temperature, the ingredients are heated up and the ingredients lose moisture. The moisture is evaporated and said moisture in turn increases the humidity of the air inside the chamber 622. Heating and humidification in hemispherical chamber 622 increases the humidity of inside air and the drying becomes ineffective. The lifting mechanism 610 and the air change mechanism 660 facilitate the removal of hot and humid air from the chamber 622.

At the first stage, air gap is created between inner hemispherical chamber 622 and the outer assembly of first dome 601 and second domes 620 along with movable flanged pipe 662. Air gap is created by turning the lever 680 to the required rotations for all the predesigned graduated bolts 688 of lifting mechanisms 610, one by one. At the second stage, the air vent moving vanes 902 of the air change mechanism 660 are rotated to create a path for hot and humid air to escape. At the third stage, the axial blower 906 is activated thus forcing out the hot humid air and sucking in the fresh ambient air through gap created at bottom by lifting mechanism 610. Temperature and humidity in the chamber 662 will be reduced then axial blower is deactivated, Air vent moving vanes 902 are brought back to original position, preventing path for air change. The lifting mechanism 610 is again operated and brought back to original settings. The heating and drying cycle again is repeated, until the air in the inside chamber 662 reaches closer to saturation level. Saturation level is monitored using the temperature sensor and the humidity sensor (not seen in drawings). For other moderate drying operations, for example, freshly harvested grains and cereals (moisture content up to 20%), the air change mechanism 660 and gap defined by the bottom of the dryer 600 by lifting mechanism 610 is adjusted at predefined level for continual drying operation.

Once the ingredients are dried to the required level, the trays 808 are offloaded one by one. Trays are emptied, clean and dried and put back in the system again to be used for next batch of the drying. The drying chamber 209 of the dryer 100 of the present invention, in association with methods known in the prior art, is advantageously usable for adding humidity with heating of inside air. It is to be noted that such hot and humid environment is used for sanitization/disinfection of some pathogens like SARS-CoV2. One can disinfect personal accessories like mask, hand gloves, aprons, and the like with the dryer 100 of the present invention.

The air mixing fan 908 is used to ensure that the temperature inside the chamber 662 is uniform. It is in operation intermittently/throughout the drying cycle. While the air change blower 906 is in operation, the air mixing fan 908 is deactivated.

Now one more embodiment of the present invention is discussed. For changing hot and humid air in the chamber 622 the flanged pipe is slidable along the axis Y by known mechanisms in the prior art. In this embodiment, the reciprocation of the flanged pipe along with first dome 601 and second dome 620 in accordance with the present invention is combined with air change mechanism by sensing the humidity and temperature inside the chamber.

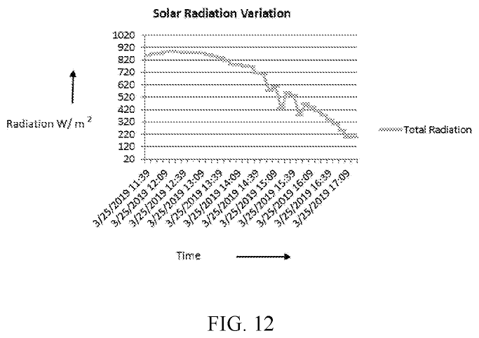

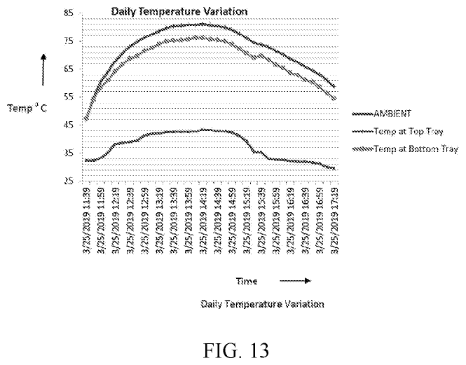

FIG. 12 is a graph that shows solar radiation variation, and FIG. 13 depicts a graph showing daily temperature variation in the dryer 100. These graphs are developed based on the experiment carried out on 15 May 2020 in Dhule City of Maharashtra State. At the beginning of the experimentation at 11.39 am, the ambient temperature noted was 34° C. and the solar radiation was found to be 830 W/m².

It is seen that the ambient temperature gradually increases and reaches the peak of 42° C. as shown in the graph and towards the end of the day ambient temperature reduces to 27° C. The solar radiation which was noted as 830 W/m² progressively increases to maximum level of 910 W/m² and diminishes to 160 W/m² towards the end of the experimentation. At the beginning of the experimentation the temperature of the air in the vicinity of the top tray and in the vicinity of the bottom tray is at the same level which is around 48° C. During the experimentation as solar dryer is exposed to solar radiation the temperature of the air in the vicinity of the top tray and in the vicinity of the bottom tray gradually increases to a maximum level of 75° C. and 83° C. respectively corresponding to the ambient of 42° C. During experimentation, the delta between the temperature in the vicinity of the top tray and the temperature in the vicinity of the bottom tray is observed to be 8° C., approximately.

As the temperature increases in the dryer of the present invention, moisture content in the placed ingredients gets vaporized. Increased temperature also destroys harmful micro-organisms, insects, worms, worm eggs and similar microbes. The design of the dryer disclosed in accordance with the present invention advantageously efficient as there is maximum utilization of the available solar energy.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

1. A modular solar dryer 100 for drying and physical disinfection of ingredients comprising:
a first hemispherical dome 104, the first dome 104 being positioned on a circular base 106;
a hemispherical second dome 208, the second dome 208 being positioned below the first dome 104 defining a drying a chamber 209 between the inner surface of the second dome, an inner surface of the base 106 and a platform on which dryer 100 is positioned;
a set of utensils 210, 212 positioned on a stand 214 within the drying chamber 209;
the base 106 receiving the first dome 104, the second dome 208 and a seal 216 along the periphery;
a cylindrical chamber 201, the cylindrical chamber defined in a top end portion of the dryer 100 including a printed circuit board assembly (PCBA) 202, a motor 204 and an air circulator 206, the cylindrical chamber 201 being covered from top by the cover 108;
the PCBA including a controller 112, a first sensor 224, and a second sensor 226 controlling the motor 204 and a solenoid valve 218, the controller 112 is configured to operate the dryer 100 in two modes;
a user device 114, the user device including a controller 112 and a display; the controller 112 being configured to receive real time notifications related to drying updates and to communicate with the controller 112 of the dryer 100;
a first mode of the dryer 100 with moisture content with temperature based drying; and
a second mode of the dryer 100 with temperature and exposed duration based drying.

2. The modular solar dryer as claimed in claim 1, wherein some portion of the first dome 104 and second dome 208 is always normal to the incident solar energy during drying operation.

3. The modular solar dryer as claimed in claim 1, wherein the first dome 104 and second dome 208 are made using a multiple straight planner segments that are bent in vertical direction using a single radius or a multiple radii and such segment are joined together at the ends to define arcuate shape.

4. The modular solar dryer as claimed in claim 1, wherein the air space between the first dome 104, the second dome 208 and the base 106 defines an insulation preventing the heat loss from the dryer 100.

5. The modular solar dryer as claimed in claim 1, wherein a pair of utensils 210, 212 is coated with heat absorbing material to absorb heat energy.

6. The modular solar dryer as claimed in claim 1, wherein the solenoid valve 218 is positioned on the base 106 for opening and closing of the air passage as per the controller signals.

7. The modular solar dryer as claimed in claim 1, wherein the air circulator 206 is activable by the controller 112 as per time interval, temperature, and humidity.

8. The modular solar dryer as claimed in claim 1, wherein the first sensor 224 is humidity sensor and the second sensor 226 is temperature sensor.

9. The modular solar dryer as claimed in claim 1, wherein the controller 112 monitors time, temperature and humidity inside the dryer, and maps such parameters to the user device 114.

10. The modular solar dryer as claimed in claim 1, wherein user device 114 is configured to receive real-time updates regarding drying process notifications related to temperature, humidity and drying duration from the controller 112.

11. The modular solar dryer as claimed in claim 1, wherein user device 114 is configured to observe and control the operation of the dryer by sending the instructions to the controller 112 as per the desired drying needs.

12. A modular solar dryer 500 for drying and physical disinfection of ingredients comprising:
a first dome 504, the first dome 504 is hollow and hemispherical in shape and includes a handle 102 attached at top centre of its outer side;
a base 506, the base 506 is circular ring that receives the first dome 504 along periphery of the first dome 504;
a second dome 508, second dome 508 is hollow and hemispherical shaped;
a drying chamber 509, the drying chamber 509 defined by a space between the second dome 508, an inner diameter of the base 506, and a platform 518;
a utensil assembly 503, the utensil assembly 503 includes a first utensil 510, a second utensil 512, for holding items to be dried and a stand 514; positioned within the drying chamber 509; and
a seal 516, the seal 516 is positioned in the proximity with the peripheral edge of the base 506 on bottom side.

13. A modular solar dryer 600 for drying and physical disinfection of ingredients comprising:
a first dome 601, first dome 601 is formed by plurality of curved segments 612, when assembled together on a first support grill 618;
the first support grill 618, the support grill 618 is assembled by arranging a plurality of curved members 616 to a movable flanged pipe 662 and a bottom ring 614;
a second dome 620, the second dome 620 assembled by arranging plurality of curved segments 708 on a second support grill 704;
the second support grill 704, the support grill 704 is assembled by arranging a plurality of curved members 706 to the flanged pipe 662 and a bottom ring 702;
a hemispherical chamber 622, the hemispherical chamber 622 is formed by a space between the second dome 620 and base surface;
a tray stand 640, the tray stand is rotatable about the axis Y-Y on a guide railing 624 with help of a rolling wheel 812;
a sliding door 602, the sliding door 602 is slidably positionable between a guiding track 604 and the guide rail 606;
an air change unit 660, the air change unit 660 includes of a pair of plates 902 and 904, with a plurality of slits that enables controllable air flow through the dryer;
a lifting unit 610, the lifting unit is positioned on the support grill 618 of first dome 601 for facilitating the air change mechanism; and
a perforated pipe 642, the perforated pipe 642 is a structural member that includes tray partitions 802, the perforated pipe 642 connects with flange pipe 662.

14. The modular solar dryer as claimed in claim 13, wherein the flanged pipe 662 connects the first dome 601 and the second dome 620 to the perforated pipe 642 and enables air flow passage from hemispherical chamber 622 to outer environment.

15. The modular solar dryer as claimed in claim 12, wherein the dryer is operable in two modes such as a first drying mode and a second disinfection mode that are operated by a knob 1000 in association of the vent valve 1024.
